(19) United States
(12) Patent Application Publication
(10) Pub. No.: US 2003/0019669 A1
(43) Pub. Date: Jan. 30, 2003

(54) Ultrasonic touch-position sensing system

(76) Inventor: Kohji Toda, Yokosuka (JP)

Correspondence Address: Kohji Toda, 1-49-18 Futaba, Yokosuka, 239-0814, JP

(21) Appl. No.: 09/916,740

(22) Filed: Jul. 26, 2001

(51) Int. Cl. G09G 5/00

(52) U.S. Cl. 178/18.04

(57) ABSTRACT

An ultrasonic touch-position sensing system comprises a nonpiezoelectric plate, at least one transducer-unit formed on an upper end surface of the nonpiezoelectric plate, and a signal analyzer. The transducer-unit consists of at least one input IDT Tᵢ (i=1, 2, . . . , m), at least one output IDT Rᵢ (i=1, 2, . . . , m), at least one transmitting IDT Mᵢ (i=1, 2, . . . , m), a receiving IDT, an input piezoelectric substrate, and an output piezoelectric substrate. The output IDT Rᵢ has the electrode-finger direction slanting to that of the input IDT Tᵢ by an angle θ. If an input electric signal is applied to the input IDT Tᵢ, a first SAW is excited in the input piezoelectric substrate. The first SAW is transmitted to the output piezoelectric substrate along the upper end surface of the nonpiezoelectric plate, and then, transduced to electric signals Eⱼ (j=1, 2, . . . , n) at the output. Thus, SAW propagation lanes Wⱼ (j=1, 2, . . . , n) on the upper end surface of the nonpiezoelectric plate are formed between the input IDT Tᵢ and the output IDT Rᵢ. If touching one of the SAW propagation lanes Wⱼ, one of the electric signals Eⱼ is detected at the output IDT Rᵢ, and then, it is applied to the transmitting IDT Mᵢ. In this time, a second SAW is excited in the output piezoelectric substrate. The second SAW is transduced to an output electric signal at the receiving IDT. Thus, a touch position on the one of the SAW propagation lanes Wⱼ is sensed by the phase of the output electric signal.

### BACKGROUND OF THE INVENTION

1. Field of the Invention

The present invention relates to an ultrasonic touch-position sensing system for sensing a touch position on a nonpiezoelectric plate by means of using at least one transducer-unit, and a signal analyzer.

2. Description of the Prior Art

Conventional touch panel having an ultrasonic transducer as a wedge-shaped transducer, a piezoelectric thin film transducer, and so on, senses a touch position on a nonpiezoelectric plate from a disappearance of an output electric signal, which disappears in response to a disappearance of an ultrasound on the nonpiezoelectric plate by touching thereon. Therefore, conventional touch panel needs a high voltage operation with a high power consumption, and a large-scale circuit with a complicated structure. In addition, it is difficult for conventional touch panel to realize a quick response-time, an accurate detection of a minute touch position. Moreover, there are some problems on manufacturing, and mass production.

### SUMMARY OF THE INVENTION

An object of the present invention is to provide an ultrasonic touch-position sensing system capable of sensing a touch position on a nonpiezoelectric plate from an appearance of an output electric signal, which appears in response to a disappearance of an ultrasound on the nonpiezoelectric plate by touching thereon.

Another object of the present invention is to provide an ultrasonic touch-position sensing system capable of sensing a touch position on the nonpiezoelectric plate from an appearance of a pulse, which appears in response to the disappearance of the ultrasound on the nonpiezoelectric plate by touching thereon.

Another object of the present invention is to provide an ultrasonic touch-position sensing system capable of accurate sensing of a minute touch position on the nonpiezoelectric plate with a high sensitivity and a quick response time.

Another object of the present invention is to provide an ultrasonic touch-position sensing system excellent in manufacturing and mass production.

Another object of the present invention is to provide an ultrasonic touch-position sensing system operating under low electric power consumption with low voltage.

A still other object of the present invention is to provide an ultrasonic touch-position sensing system having a small-sized circuit with a simple structure which is very light in weight.

According to one aspect of the present invention there is provided an ultrasonic touch-position sensing system comprising a nonpiezoelectric plate, at least one transducer-unit formed on an upper end surface of the nonpiezoelectric plate, and a signal analyzer. The transducer-unit consists of at least one input interdigital transducer (IDT) Tᵢ (i=1, 2, . . . , m), at least one output IDT Rᵢ (i=1, 2, . . . , m), at least one transmitting IDT Mᵢ (i=1, 2, . . . , m), a receiving IDT, an input piezoelectric substrate, and an output piezoelectric substrate. The input IDT Tᵢ has an interdigital periodicity P and an overlap length L. The output IDT Rᵢ has the electrode-finger direction slanting to that of the input IDT Tᵢ by an angle θ, an interdigital periodicity P_{N} along the orthogonal direction to the electrode-finger direction of the output IDT Rᵢ, and an overlap length L_{P} along the electrode-finger direction of the output IDT Rᵢ. The receiving IDT has the electrode-finger direction parallel to that of the transmitting IDT Mᵢ.

If an input electric signal is applied to the input IDT Tᵢ, a first surface acoustic wave (SAW) is excited in the input piezoelectric substrate. The first SAW is transmitted to the output piezoelectric substrate along the upper end surface of the nonpiezoelectric plate, and then, transduced to electric signals Eⱼ (j=1, 2, . . . , n) at the output IDT Rᵢ. Thus, SAW propagation lanes Wⱼ (j=1, 2, . . . , n) on the upper end surface of the nonpiezoelectric plate are formed between the input IDT Tᵢ and the output IDT Rᵢ. If touching one of the SAW propagation lanes Wⱼ, one of the electric signals Eⱼ is detected at the output IDT Rᵢ, and then, it is applied to the transmitting IDT Mᵢ. In this time, a second SAW is excited in the output piezoelectric substrate. The second SAW is transduced to an output electric signal at the receiving IDT. Thus, a touch position on the one of the SAW propagation lanes Wⱼ is sensed by the phase of the output electric signal.

According to another aspect of the present invention there is provided at least one output IDT Rᵢ having the interdigital periodicity P_{N} which is equal to the product of the interdigital periodicity P and cos θ, and the overlap length L_{P} which is equal to not only the product of the overlap length L and sec θ, but also the product of the interdigital periodicity P and cosec θ.

According to another aspect of the present invention there are provided input-, and output piezoelectric substrates made of a piezoelectric ceramic, respectively, the polarization axis thereof being parallel to the thickness direction thereof.

According to another aspect of the present invention there are provided input-, and output piezoelectric substrates having a thickness smaller than the interdigital periodicity P, and a nonpiezoelectric plate having a thickness larger than three times the interdigital periodicity P.

According to another aspect of the present invention there is provided an ultrasonic touch-position sensing system, wherein the phase velocity of the first SAW on the nonpiezoelectric plate alone is higher than that in the input-, and output piezoelectric substrates alone.

According to another aspect of the present invention there is provided an amplifier connected between the signal analyzer and the input IDT Tᵢ.

According to other aspect of the present invention there are provided at least one coding IDT Cᵢ (i=1, 2, . . . , m) and a decoding IDT, in place of the transmitting IDT Mᵢ and the receiving IDT, respectively. The coding IDT Cᵢ consists of interdigital electrode pairs and having a coded pattern. The decoding IDT has the same construction pattern as the coding IDT Cᵢ. If touching one of the SAW propagation lanes Wⱼ, one of the electric signals Eⱼ is detected at the output IDT Rᵢ, and then, it is applied to the coding IDT Cᵢ. In this time, a second SAW based on the coded pattern is excited in the output piezoelectric substrate. The second SAW arrives at decoding IDT, and a pulse is detected at the decoding IDT. Thus, a touch position on the one of the SAW propagation lanes Wⱼ is sensed by the phase of the pulse.

According to a further aspect of the present invention there is provided the transducer-unit comprising at least two input IDTs Tᵢ, at least two output IDTs Rᵢ, a common transmitting IDT, the receiving IDT, the input piezoelectric substrate, the output piezoelectric substrate, and a switch connected with the input IDTs Tᵢ.

If an input electric signal is applied to one of the input IDTs Tᵢ via the switch, a first SAW is excited in the input piezoelectric substrate. The first SAW is transmitted to the output piezoelectric substrate along the upper end surface of the nonpiezoelectric plate, and then, transduced to electric signals Eⱼ (j=1, 2, . . . , n) at one of the output IDTs Rᵢ. Thus, SAW propagation lanes Wⱼ (j=1, 2, . . . , n) on the upper end surface of the nonpiezoelectric plate are formed between the one of the input IDTs Tᵢ and the one of the output IDTs Rᵢ. If touching one of the SAW propagation lanes Wⱼ, one of the electric signals Eⱼ is detected at the one of the output IDT Rᵢ, and then, it is applied to the common transmitting IDT Mᵢ. In this time, a second SAW is excited in the output piezoelectric substrate. The second SAW is transduced to an output electric signal at the receiving IDT. Thus, a touch position on the one of the SAW propagation lanes Wⱼ is sensed by finding out the phase of the output electric signal, and by checking which of the input IDTs Tᵢ receives the input electric signal when the output electric signal appears at the receiving IDT.

In addition, it is possible to use a coding IDT and a decoding IDT, in place of the common transmitting IDT and the receiving IDT, respectively. If touching one of the SAW propagation lanes Wⱼ, one of the electric signals Eⱼ is detected at the one of the output IDT Rᵢ, and then, it is applied to the coding IDT. In this time, a second SAW is excited in the output piezoelectric substrate. The second SAW arrives at decoding IDT, and a pulse is detected at the decoding IDT. Thus, a touch position on the one of the SAW propagation lanes Wⱼ is sensed by finding out the phase of the pulse, and by checking which of the input IDTs Tᵢ receives the input electric signal when the pulse appears at the receiving IDT.

### BRIEF DESCRIPTION OF THE DRAWINGS

Other features and advantages of the invention will be clarified from the following description with reference to the attached drawings.

FIG. 1 shows a schematic illustration of an ultrasonic touch-position sensing system according to a first embodiment of the present invention.

FIG. 2 shows a plan view of assembly IDT Aₓ₁.

FIG. 3 shows a sectional view of the ultrasonic touch-position sensing system in FIG. 1.

FIG. 4 shows a relationship between the phase delay and the touch position on the SAW propagation lanes Wₓⱼ.

FIG. 5 shows an ultrasonic touch-position sensing system according to a second embodiment of the present invention.

FIG. 6 shows an ultrasonic touch-position sensing system according to a third embodiment of the present invention.

FIG. 7 shows a plan view of coding IDT Cₓ₁, which consists of seven interdigital electrode pairs.

FIG. 8 shows an ultrasonic touch-position sensing system according to a fourth embodiment of the present invention.

### DETAILED DESCRIPTION OF THE PRESENTLY PREFERRED EXEMPLARY EMBODIMENTS

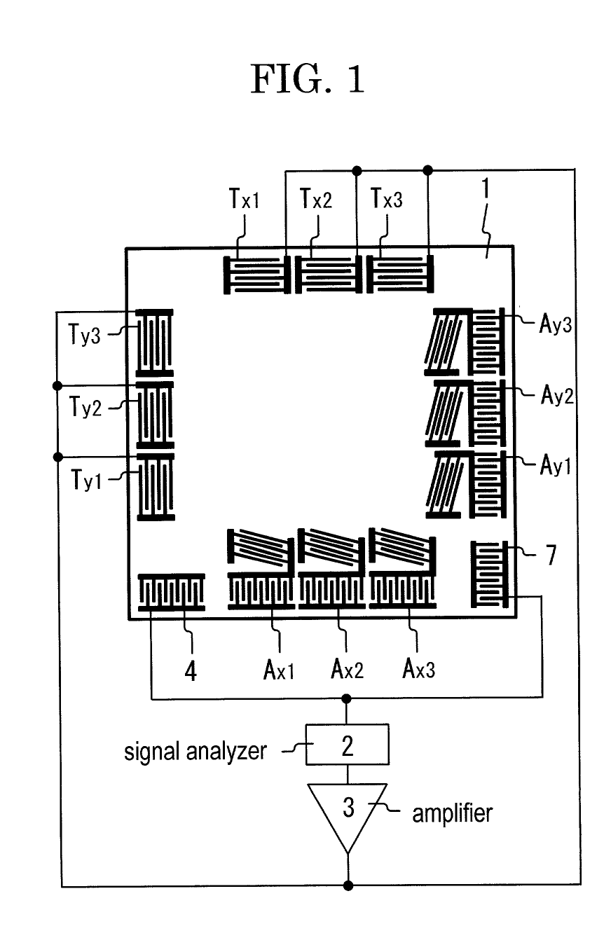

FIG. 1 shows a schematic illustration of an ultrasonic touch-position sensing system according to a first embodiment of the present invention. The ultrasonic touch-position sensing system comprises nonpiezoelectric plate 1, signal analyzer 2, amplifier 3, and two transducer-units. One transducer-unit comprises input IDTs (Tₓ₁, Tₓ₂, and Tₓ₃), output IDTs (Rₓ₁, Rₓ₂, and Rₓ₃), transmitting IDTs (Mₓ₁, Mₓ₂, and Mₓ₃), receiving IDT 4, input piezoelectric substrate 5, and output piezoelectric substrate 6. The other transducer-unit comprises input IDTs (T_{y1}, T_{y2}, and T_{y3}), output IDTs (R_{y1}, R_{y2}, and R_{y3}), transmitting IDTs (M_{y1}, M_{y2}, and M_{y3}), receiving IDT 7, input piezoelectric substrate 8, and output piezoelectric substrate 9. Output IDTs (Rₓ₁, Rₓ₂, and Rₓ₃) and transmitting IDTs (Mₓ₁, Mₓ₂, and Mₓ₃) form assembly IDTs (Aₓ₁, Aₓ₂, and Aₓ₃), respectively. Output IDTs (R_{y1}, R_{y2}, and R_{y3}), transmitting IDTs (M_{y1}, M_{y2}, and M_{y3}) form assembly IDTs (A_{y1}, A_{y2}, and A_{y3}), respectively. All the input IDTs (Tₓ₁, Tₓ₂, Tₓ₃, T_{y1}, T_{y2}, and T_{y3}), all the assembly IDTs (Aₓ₁, Aₓ₂, Aₓ₃, A_{y1}, A_{y2}, and A_{y3}), and receiving IDTs (4 and 7) are made of an aluminum thin film, respectively. Input piezoelectric substrates (5 and 8), and output piezoelectric substrates (6 and 9) are not drawn in FIG. 1. All the input IDTs (Tₓ₁, Tₓ₂, Tₓ₃, T_{y1}, T_{y2}, and T_{y3}) have an interdigital periodicity P (400 μm) and an overlap length L (12 mm).

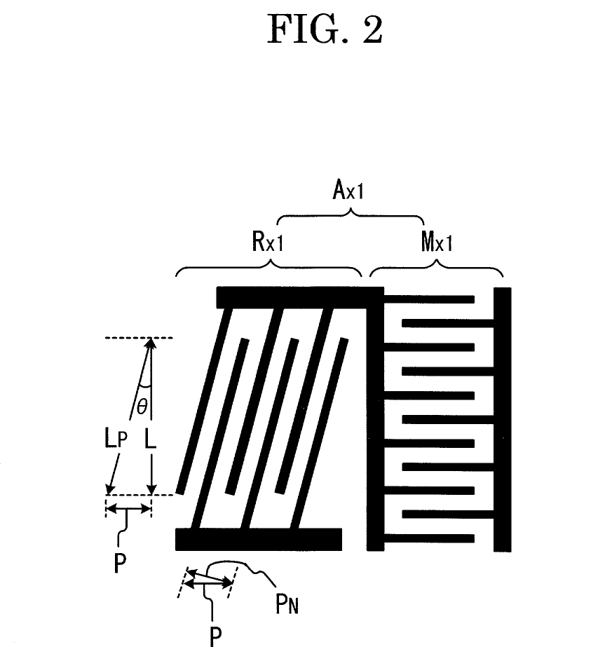

FIG. 2 shows a plan view of assembly IDT Aₓ₁. Output IDT Rₓ₁ is located such that the electrode-finger direction thereof is slanting to that of input IDT Tₓ₁ by an angle θ. And then, output IDT Rₓ₁ has an interdigital periodicity P_{N} along the orthogonal direction to the electrode-finger direction thereof, and has an overlap length L_{P} along the electrode-finger direction thereof. The interdigital periodicity P_{N} is equal to the product of the interdigital periodicity P and cos θ, and the overlap length L_{P} is equal to not only the product of the overlap length L and sec θ, but also the product of the interdigital periodicity P and cosec θ. Transmitting IDT Mₓ₁ with the interdigital periodicity P has the electrode-finger direction orthogonal to that of input IDT Tₓ₁. Another assembly IDTs (Aₓ₂, Aₓ₃, A_{y1}, A_{y2}, and A_{y3}) have the same construction patterns as assembly IDT Aₓ₁. Receiving IDTs (4 and 7) have the same construction patterns as transmitting IDTs (Mₓ₁, Mₓ₂, Mₓ₃, M_{y1}, M_{y2}, and M_{y3}). In addition, the electrode-finger direction of receiving IDT 4 is parallel to that of transmitting IDTs (Mₓ₁, Mₓ₂, and Mₓ₃), and the electrode-finger direction of receiving IDT 7 is parallel to that of transmitting IDTs (M_{y1}, M_{y2}, and M_{y3}).

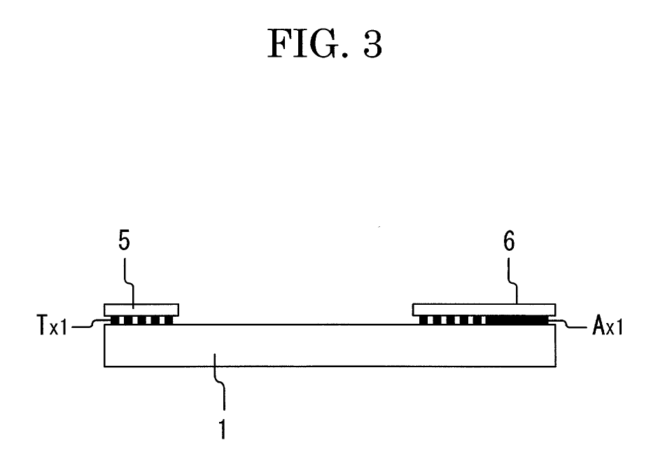

FIG. 3 shows a sectional view of the ultrasonic touch-position sensing system in FIG. 1. Input IDTs (Tₓ₂, Tₓ₃, T_{y1}, T_{y2}, and T_{y3}), assembly IDTs (Aₓ₂, Aₓ₃, A_{y1}, A_{y2}, and A_{y3}), signal analyzer 2, amplifier 3, receiving IDTs (4 and 7), input piezoelectric substrate 8, and output piezoelectric substrate 9 are not drawn in FIG. 3. Nonpiezoelectric plate 1, made of a glass plate, has a dimension of 1.5 mm in thickness. Input piezoelectric substrates (5 and 8), and output piezoelectric substrates (6 and 9) are made of a piezoelectric ceramic thin plate with a dimension of 150 μm in thickness, respectively, and the polarization axis thereof is parallel to the thickness direction thereof. Input piezoelectric substrate 5 is mounted on input IDTs (Tₓ₁, Tₓ₂, and Tₓ₃). In the same way, input piezoelectric substrate 8 is mounted on input IDTs (T_{y1}, T_{y2}, and T_{y3}). Output piezoelectric substrate 6 is mounted on assembly IDTs (Aₓ₁, Aₓ₂, and Aₓ₃) and receiving IDT 4. In the same way, output piezoelectric substrate 9 is mounted on assembly IDTs (A_{y1}, A_{y2}, and A_{y3}) and receiving IDT 7.

In the ultrasonic touch-position sensing system in FIG. 1, if an input electric signal is applied to input IDTs (Tₓ₁, Tₓ₂, Tₓ₃, T_{y1}, T_{y2}, and T_{y3}), respectively, a first SAW is excited in both input piezoelectric substrates (5 and 8). In this time, because input piezoelectric substrates (5 and 8) are made of a piezoelectric ceramic, respectively, and the polarization axis thereof is parallel to the thickness direction thereof, the first SAW is effectively excited in both input piezoelectric substrates (5 and 8). In addition, if the phase velocity of the first SAW is approximately the same as that of the Rayleigh wave traveling on nonpiezoelectric plate 1 alone, the input electric signal is effectively transduced to the first SAW.

The first SAWs excited in input piezoelectric substrates (5 and 8) are effectively transmitted to output piezoelectric substrates (6 and 9), respectively, along the upper end surface of nonpiezoelectric plate 1 without a leakage of the first SAW into the inside of nonpiezoelectric plate 1, because (1) the thickness of input piezoelectric substrates (5 and 8) is smaller than the interdigital periodicity P of input IDTs (Tₓ₁, Tₓ₂, Tₓ₃, T_{y1}, T_{y2}, and T_{y3}), (2) the thickness of nonpiezoelectric plate 1 is larger than three times the interdigital periodicity P, and (3) nonpiezoelectric plate 1 is made of the glass, in which the phase velocity of the first SAW traveling on nonpiezoelectric plate 1 alone is higher than that traveling on input piezoelectric substrates (5 and 8) alone.

The first SAW transmitted to output piezoelectric substrate 6 is transduced to electric signals Eₓⱼ (j=1, 2, . . . , n) at each of output IDTs (Rₓ₁, Rₓ₂, and Rₓ₃). In the same way, the first SAW transmitted to output piezoelectric substrate 9 is transduced to electric signals E_{yj} (j=1, 2, . . . , n) at each of output IDTs (R_{y1}, R_{y2}, and R_{y3}). Thus, three groups of SAW propagation lanes Wₓⱼ (j=1, 2, . . . , n) on the upper end surface of nonpiezoelectric plate 1 are formed between input IDTs (Tₓ₁, Tₓ₂, and Tₓ₃) and output IDTs (Rₓ₁, Rₓ₂, and Rₓ₃), respectively. At the same time, three groups of SAW propagation lanes W_{yj} (j=1, 2, . . . , n) are formed between input IDTs (T_{y1}, T_{y2}, and T_{y3}) and output IDTs (R_{y1}, R_{y2}, and R_{y3}), respectively.

If touching a position which is not only on the SAW propagation lanes Wₓⱼ between, for example, input IDT Tₓ₁ and output IDT Rₓ₁, but also on the SAW propagation lanes W_{yj} between, for example, input IDT T_{y3} and output IDT R_{y3}, one of the electric signals Eₓⱼ and one of the electric signals E_{yj} are detected at output IDTs (Rₓ₁ and R_{y3}), respectively. In other words, if touching nowhere, no electric signal is detected at all the output IDTs (Rₓ₁, Rₓ₂, Rₓ₃, R_{y1}, R_{y2}, and R_{y3}), because the sum of the phases of the electric signals Eₓⱼ which linearly correlate to the SAW propagation lanes Wₓⱼ and that of the electric signals E_{yj} which linearly correlate to the SAW propagation lanes W_{yj} are both zero as the result of phase compensation. The one, detected at output IDT Rₓ₁, of the electric signals Eₓⱼ and the one, detected at output IDT R_{y3}, of the electric signals E_{yj}, are applied to transmitting IDTs (Mₓ₁ and M_{y3}), respectively. In this time, a second SAW is excited in output piezoelectric substrates (6 and 9), respectively. When the second SAW arrives at receiving IDTs (4 and 7), respectively, it is transduced to an output electric signal. As a result, the touch position on the SAW propagation lanes (Wₓⱼ and W_{yj}) is sensed by means of the phases of the output electric signals at receiving IDTs (4 and 7), respectively.

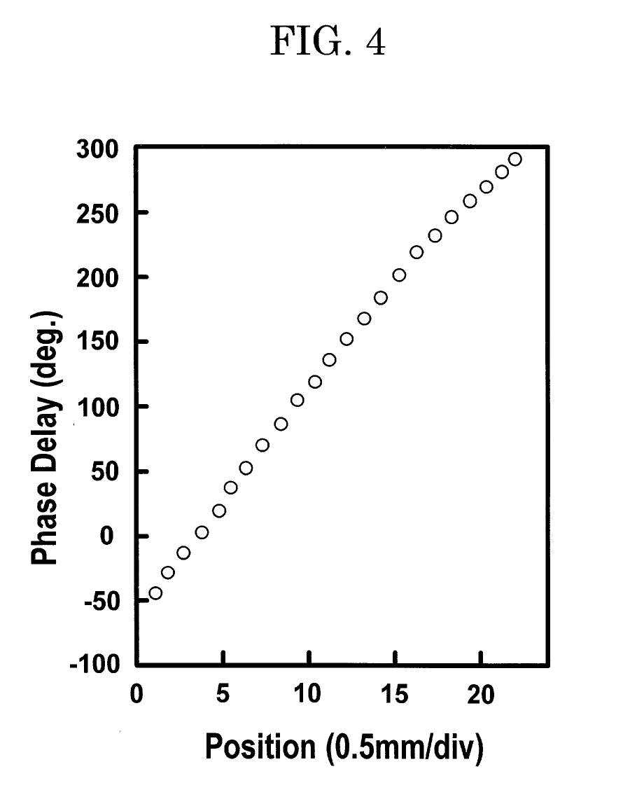

FIG. 4 shows a relationship between the phase delay and the touch position on the SAW propagation lanes Wₓⱼ. It should be noted that the touch position correlates to the phase delay.

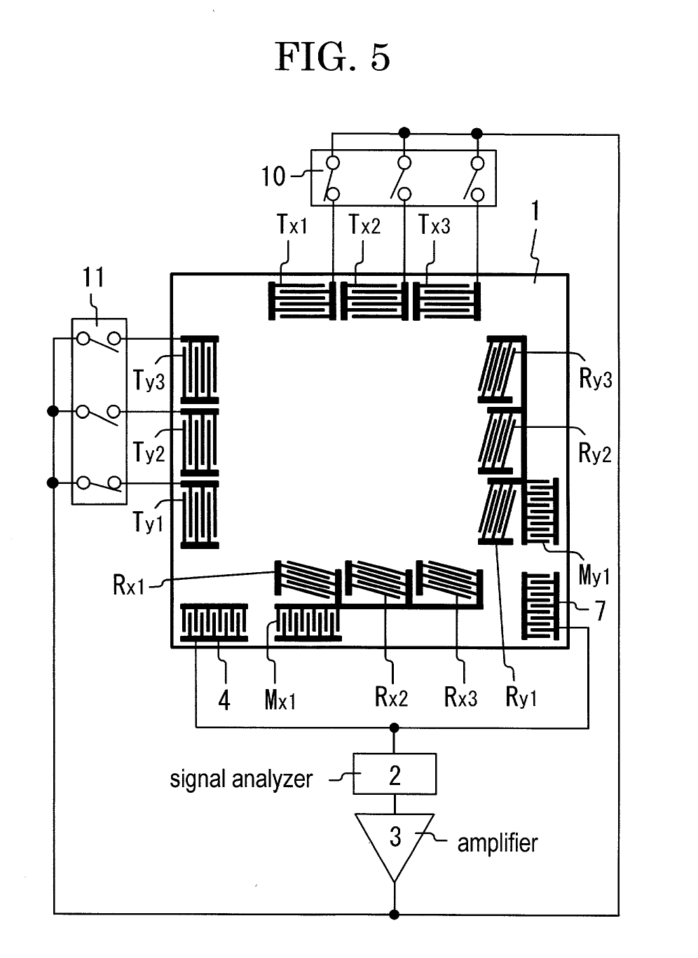

FIG. 5 shows an ultrasonic touch-position sensing system according to a second embodiment of the present invention. The ultrasonic touch-position sensing system has the same construction as FIG. 1, except for the absence of transmitting IDTs (Mₓ₂, Mₓ₃, M_{y2}, and M_{y3}), and the presence of switches (10 and 11). In other words, the ultrasonic touch-position sensing system in FIG. 5 has two common transmitting IDTs, that is, transmitting IDTs (Mₓ₁ and M_{y1}). Input piezoelectric substrates (5 and 8), and output piezoelectric substrates (6 and 9) are not drawn in FIG. 5.

In the ultrasonic touch-position sensing system in FIG. 5, if an input electric signal is applied to one of input IDTs (Tₓ₁, Tₓ₂, and Tₓ₃) via switch 10, and one of input IDTs (T_{y1}, T_{y2}, and T_{y3}) via switch 11, respectively, a first SAW is excited in both input piezoelectric substrates (5 and 8). The first SAWs excited in input piezoelectric substrates (5 and 8) are effectively transmitted to output piezoelectric substrates (6 and 9), respectively, along the upper end surface of nonpiezoelectric plate 1. The first SAW transmitted to output piezoelectric substrate 6 is transduced to electric signals Eₓⱼ at the corresponding one of output IDTs (Rₓ₁, Rₓ₂, and Rₓ₃). In the same way, the first SAW transmitted to output piezoelectric substrate 9 is transduced to electric signals E_{yj} at the corresponding one of output IDTs (R_{y1}, R_{y2}, and R_{y3}). Thus, SAW propagation lanes Wₓⱼ are formed between one of input IDTs (Tₓ₁, Tₓ₂, and Tₓ₃) and the corresponding one of output IDTs (Rₓ₁, Rₓ₂, and Rₓ₃). At the same time, SAW propagation lanes W_{yj} are formed between one of input IDTs (T_{y1}, T_{y2}, and T_{y3}) and the corresponding one of output IDTs (R_{y1}, R_{y2}, and R_{y3}).

In the ultrasonic touch-position sensing system in FIG. 5, if touching a position which is not only on the SAW propagation lanes Wₓⱼ between, for example, input IDT Tₓ₂ and output IDT Rₓ₂, but also on the SAW propagation lanes W_{yj} between, for example, input IDT T_{y3} and output IDT R_{y3}, one of the electric signals Eₓⱼ and one of the electric signals E_{yj} are detected at output IDTs (Rₓ₂ and R_{y3}), respectively. The one, detected at output IDT Rₓ₂, of the electric signals Eₓⱼ, and the one, detected at output IDT R_{y3}, of the electric signals E_{yj}, are applied to transmitting IDTs (Mₓ₁ and M_{y1}), respectively. In this time, a second SAW is excited in both output piezoelectric substrates (6 and 9). The second SAWs are transduced to output electric signals at receiving IDTs (4 and 7), respectively. As a result, the touch position on the SAW propagation lanes (Wₓⱼ and W_{yj}) is sensed by (1) checking which of input IDTs (Tₓ₁, Tₓ₂, and Tₓ₃) is connected to amplifier 3 via switch 10 when the output electric signal is detected at receiving IDT 4, (2) checking which of input IDTs (T_{y1}, T_{y2}, and T_{y3}) is connected to amplifier 3 via switch 11 when the output electric signal is detected at receiving IDT 7, and (3) finding out the phases of the output electric signals at receiving IDTs (4 and 7), respectively.

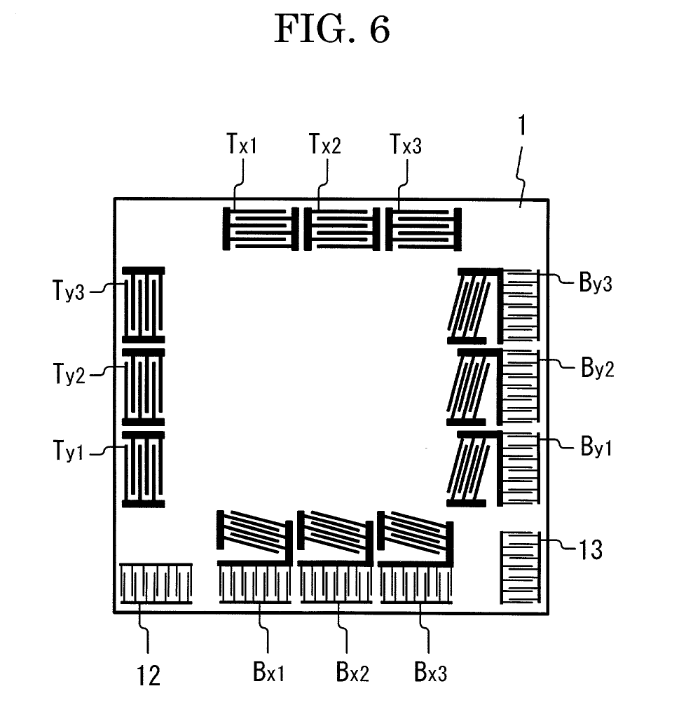

FIG. 6 shows an ultrasonic touch-position sensing system according to a third embodiment of the present invention. The ultrasonic touch-position sensing system has the same construction as FIG. 1, except for the presence of coding IDTs (Cₓ₁, Cₓ₂, Cₓ₃, C_{y1}, C_{y2}, and C_{y3}) and decoding IDTs (12 and 13) in place of transmitting IDTs (Mₓ₁, Mₓ₂, Mₓ₃, M_{y1}, M_{y2}, and M_{y3}) and receiving IDTs (4 and 7), respectively. Signal analyzer 2, amplifier 3, input piezoelectric substrates (5 and 8), and output piezoelectric substrates (6 and 9) are not drawn in FIG. 6. Output IDTs (Rₓ₁, Rₓ₂, Rₓ₃, R_{y1}, R_{y2}, and R_{y3}) and coding IDTs (Cₓ₁, Cₓ₂, Cₓ₃, C_{y1}, C_{y2}, and C_{y3}) form assembly IDTs (Bₓ₁, Bₓ₂, Bₓ₃, B_{y1}, B_{y2}, and B_{y3}), respectively.

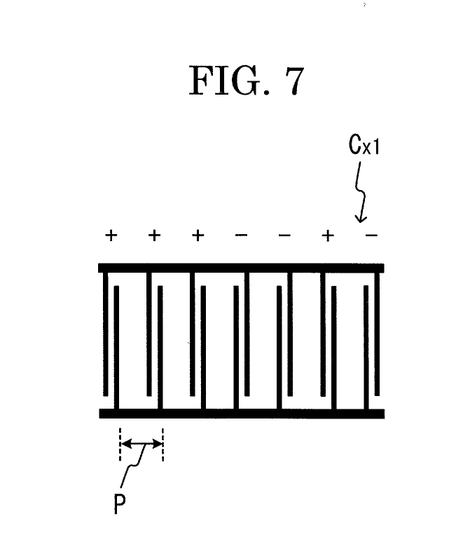

FIG. 7 shows a plan view of coding IDT Cₓ₁, which consists of seven interdigital electrode pairs. Each pair has an interdigital periodicity of 400 μm, which is the same as the interdigital periodicity P of input IDTs (Tₓ₁, Tₓ₂, Tₓ₃, T_{y1}, T_{y2}, and T_{y3}). Coding IDTs (Cₓ₁, Cₓ₂, Cₓ₃, C_{y1}, C_{y2}, and C_{y3}) have the same construction patterns from each other, and have a coded pattern based on the Baker code, respectively. Besides a seven-digits code (1, 1, 1, 0, 0, 1, 0) as shown in FIG. 7, for example, a three-digits code (1, 1, 0), an eleven-digits code (1, 1, 1, 0, 0, 0, 1, 0, 0, 1, 0), and others are available. Decoding IDTs (12 and 13) also have the same construction patterns as coding IDTs (Cₓ₁, Cₓ₂, Cₓ₃, C_{y1}, C_{y2}, and C_{y3}). The electrode-finger direction of decoding IDT 12 is parallel to that of coding IDTs (Cₓ₁, Cₓ₂, and Cₓ₃). In the same way, the electrode-finger direction of decoding IDT 13 is parallel to that of coding IDTs (C_{y1}, C_{y2}, and C_{y3}).

In the ultrasonic touch-position sensing system in FIG. 6, three groups of SAW propagation lanes Wₓⱼ on the upper end surface of nonpiezoelectric plate 1 are formed between input IDTs (Tₓ₁, Tₓ₂, and Tₓ₃) and output IDTs (Rₓ₁, Rₓ₂, and Rₓ₃), respectively, in the same way as FIG. 1. At the same time, three groups of SAW propagation lanes W_{yj} are formed between input IDTs (T_{y1}, T_{y2}, and T_{y3}) and output IDTs (R_{y1}, R_{y2}, and R_{y3}), respectively. If touching a position which is not only on the SAW propagation lanes Wₓⱼ between, for example, input IDT Tₓ₃ and output IDT Rₓ₃, but also on the SAW propagation lanes W_{yj} between, for example, input IDT T_{y1} and output IDT R_{y1}, one of the electric signals Eₓⱼ and one of the electric signals E_{yj} are detected at output IDTs (Rₓ₃ and R_{y1}), respectively. When the one, detected at output IDT Rₓ₃, of the electric signals Eₓⱼ, and the one, detected at output IDT R_{y1}, of the electric signals E_{yj}, are applied to coding IDTs (Cₓ₃ and C_{y1}), respectively, a second SAW based on the coded pattern is excited in both output piezoelectric substrates (6 and 9). The second SAWs in output piezoelectric substrates (6 and 9) are detected as pulses at decoding IDTs (12 and 13), respectively. As a result, the touch position on the SAW propagation lanes (Wₓⱼ and W_{yj}) is sensed by means of the phases of the pulses at decoding IDTs (12 and 13), respectively.

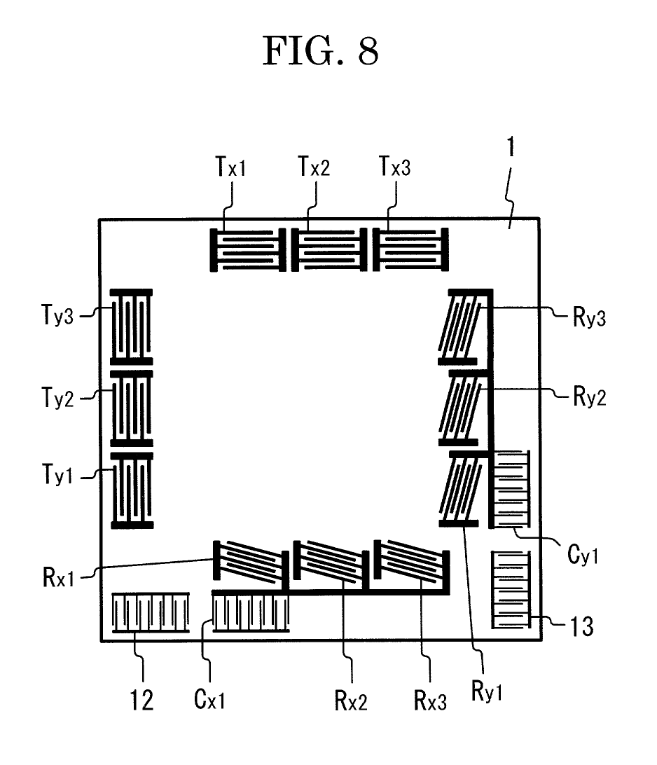

FIG. 8 shows an ultrasonic touch-position sensing system according to a fourth embodiment of the present invention. The ultrasonic touch-position sensing system has the same construction as FIG. 5, except for the presence of coding IDTs (Cₓ₁ and C_{y1}) and decoding IDTs (12 and 13), in place of transmitting IDTs (Mₓ₁ and M_{y1}) and receiving IDTs (4 and 7), respectively. In other words, the ultrasonic touch-position sensing system in FIG. 8 has two common coding IDTs, that is, coding IDTs (Cₓ₁ and C_{y1}). Signal analyzer 2, amplifier 3, input piezoelectric substrates (5 and 8), output piezoelectric substrates (6 and 9), and switches (10 and 11) are not drawn in FIG. 8.

In the ultrasonic touch-position sensing system in FIG. 8, SAW propagation lanes Wₓⱼ are formed between one of input IDTs (Tₓ₁, Tₓ₂, and Tₓ₃) and the corresponding one of output IDTs (Rₓ₁, Rₓ₂, and Rₓ₃), in the same way as FIG. 5. At the same time, SAW propagation lanes W_{yj} are formed between one of input IDTs (T_{y1}, T_{y2}, and T_{y3}) and the corresponding one of output IDTs (R_{y1}, R_{y2}, and R_{y3}). If touching a position which is not only on the SAW propagation lanes Wₓⱼ between, for example, input IDT Tₓ₂ and output IDT Rₓ₂, but also on the SAW propagation lanes W_{yj} between, for example, input IDT T_{y1} and output IDT R_{y1}, one of the electric signals Eₓⱼ and one of the electric signals E_{yj} are detected at output IDTs (Rₓ₂ and R_{y1}), respectively. When the one, detected at output IDT Rₓ₂, of the electric signals Eₓⱼ, and the one, detected at output IDT R_{y1}, of the electric signals E_{yj} are applied to coding IDTs (Cₓ₁ and C_{y1}), respectively, a second SAW based on the coded pattern is excited in both output piezoelectric substrates (6 and 9). The second SAWs in output piezoelectric substrates (6 and 9) are detected as pulses at decoding IDTs (12 and 13), respectively. As a result, the touch position on the SAW propagation lanes (Wₓⱼ and W_{yj}) is sensed by (1) checking which of input IDTs (Tₓ₁, Tₓ₂, and Tₓ₃) is connected to amplifier 3 via switch 10 when the pulse is detected at decoding IDT 12, (2) checking which of input IDTs (T_{y1}, T_{y2}, and T_{y3}) is connected to amplifier 3 via switch 11 when the pulse is detected at decoding IDT 13, and (3) finding out the phases of the pulses at decoding IDTs (12 and 13), respectively.

While this invention has been described in connection with what is presently considered to be the most practical and preferred embodiment, it is to be understood that the invention is not limited to the disclosed embodiment, but, on the contrary, is intended to cover various modifications and equivalent arrangements included within the spirit and scope of the appended claims.

What is claimed is:

1. An ultrasonic touch-position sensing system comprising:
a nonpiezoelectric plate;
at least one transducer-unit formed on an upper end surface of said nonpiezoelectric plate and consisting of
at least one input IDT Tᵢ (i=1, 2, . . . , m) having an interdigital periodicity P and an overlap length L,
at least one output IDT Rᵢ (i=1, 2, . . . , m) having the electrode-finger direction slanting to that of said at least one input IDT Tᵢ by an angle θ, and having an interdigital periodicity P_{N} along the orthogonal direction to said electrode-finger direction of said at least one output IDT Rᵢ and an overlap length L_{P} along said electrode-finger direction of said at least one output IDT Rᵢ,
at least one transmitting IDT Mᵢ (i=1, 2, . . . , m),
a receiving IDT having the electrode-finger direction parallel to that of said at least one transmitting IDT Mᵢ,
an input piezoelectric substrate,
an output piezoelectric substrate; and
a signal analyzer connected to said receiving IDT,
said at least one input IDT Tᵢ receiving an input electric signal, exciting a first SAW in said input piezoelectric substrate, and transmitting said first SAW to said output piezoelectric substrate along said upper end surface of said nonpiezoelectric plate,
said at least one output IDT Rᵢ transducing said first SAW to electric signals Eⱼ (j=1, 2, . . . , n), of which the phase delays linearly correlate to SAW propagation lanes Wⱼ (j=1, 2, . . . , n) between said at least one input IDT Tᵢ and said at least one output IDT Rᵢ on said upper end surface of said nonpiezoelectric plate, and detecting one of said electric signals Eⱼ only when touching one of said SAW propagation lanes Wⱼ,
said at least one transmitting IDT Mᵢ receiving said one of said electric signals Eⱼ, and exciting a second SAW in said output piezoelectric substrate,
said receiving IDT transducing said second SAW to an output electric signal, and
said signal analyzer sensing said one of said SAW propagation lanes Wⱼ by means of the phase of said output electric signal.

2. An ultrasonic touch-position sensing system as defined in claim 1, wherein said interdigital periodicity P_{N} is equal to the product of said interdigital periodicity P and cos θ, and said overlap length L_{P} is equal to not only the product of said overlap length L and sec θ, but also the product of said interdigital periodicity P and cosec θ.

3. An ultrasonic touch-position sensing system as defined in claim 1, wherein said input-, and output piezoelectric substrates are made of a piezoelectric ceramic, respectively, the polarization axis thereof being parallel to the thickness direction thereof.

4. An ultrasonic touch-position sensing system as defined in claim 1, wherein said input-, and output piezoelectric substrates have a thickness smaller than said interdigital periodicity P, and said nonpiezoelectric plate has a thickness larger than three times said interdigital periodicity P.

5. An ultrasonic touch-position sensing system as defined in claim 1, wherein the phase velocity of said first SAW on said nonpiezoelectric plate alone is higher than that in said input-, and output piezoelectric substrates alone.

6. An ultrasonic touch-position sensing system as defined in claim 1 further comprising an amplifier connected between said signal analyzer and said at least one input IDT Tᵢ.

7. An ultrasonic touch-position sensing system comprising:
a nonpiezoelectric plate;
at least one transducer-unit formed on an upper end surface of said nonpiezoelectric plate and consisting of
at least one input IDT Tᵢ (i=1, 2, . . . , m) having an interdigital periodicity P and an overlap length L,
at least one output IDT Rᵢ (i=1, 2, . . . , m) having the electrode-finger direction slanting to that of said at least one input IDT Tᵢ by an angle θ, and having an interdigital periodicity P_{N} along the orthogonal direction to said electrode-finger direction of said at least one output IDT Rᵢ and an overlap length L_{P} along said electrode-finger direction of said at least one output IDT Rᵢ,
at least one coding IDT Cᵢ (i=1, 2, . . . , m) consisting of interdigital electrode pairs and having a coded pattern,
a decoding IDT having the same construction pattern as said at least one coding IDT Cᵢ, and the electrode-finger direction parallel to that of said at least one coding IDT Cᵢ,
an input piezoelectric substrate,
an output piezoelectric substrate; and
a signal analyzer connected to said decoding IDT,
said at least one input IDT Tᵢ receiving an input electric signal, exciting a first SAW in said input piezoelectric substrate, and transmitting said first SAW to said output piezoelectric substrate along said upper end surface of said nonpiezoelectric plate,
said at least one output IDT Rᵢ transducing said first SAW to electric signals Eⱼ (j=1, 2, . . . , n), of which the phase delays linearly correlate to SAW propagation lanes Wⱼ (j=1, 2, . . . , n) between said at least one input IDT Tᵢ and said at least one output IDT Rᵢ on said upper end surface of said nonpiezoelectric plate, and detecting one of said electric signals Eⱼ only when touching one of said SAW propagation lanes Wⱼ,
said at least one coding IDT Cᵢ receiving said one of said electric signals Eⱼ, and exciting a second SAW based on said coded pattern in said output piezoelectric substrate,
said decoding IDT detecting a pulse when receiving said second SAW, and
said signal analyzer sensing said one of said SAW propagation lanes Wⱼ by means of the phase of said pulse.

8. An ultrasonic touch-position sensing system as defined in claim 7, wherein said interdigital periodicity P_{N} is equal to the product of said interdigital periodicity P and cos θ, and said overlap length L_{P} is equal to not only the product of said overlap length L and sec θ, but also the product of said interdigital periodicity P and cosec θ.

9. An ultrasonic touch-position sensing system as defined in claim 7, wherein said input-, and output piezoelectric substrates are made of a piezoelectric ceramic, respectively, the polarization axis thereof being parallel to the thickness direction thereof.

10. An ultrasonic touch-position sensing system as defined in claim 7, wherein said input-, and output piezoelectric substrates have a thickness smaller than said interdigital periodicity P, and said nonpiezoelectric plate has a thickness larger than three times said interdigital periodicity P.

11. An ultrasonic touch-position sensing system as defined in claim 7, wherein the phase velocity of said first SAW on said nonpiezoelectric plate alone is higher than that in said input-, and output piezoelectric substrates alone.

12. An ultrasonic touch-position sensing system as defined in claim 7 further comprising an amplifier connected between said signal analyzer and said at least one input IDT Tᵢ.

13. An ultrasonic touch-position sensing system comprising:
a nonpiezoelectric plate;
at least one transducer-unit formed on an upper end surface of said nonpiezoelectric plate and consisting of
at least two input IDTs Tᵢ (i=1, 2, . . . , m) having an interdigital periodicity P and an overlap length L,
at least two output IDTs Rᵢ (i=1, 2, . . . , m) having the electrode-finger direction slanting to that of said input IDTs Tᵢ by an angle θ, and having an interdigital periodicity P_{N} along the orthogonal direction to said electrode-finger direction of said output IDTs Rᵢ and an overlap length L_{P} along said electrode-finger direction of said output IDTs Rᵢ,
a common transmitting IDT,
a receiving IDT having the electrode-finger direction parallel to that of said common transmitting IDT,
an input piezoelectric substrate,
an output piezoelectric substrate,
a switch connected with said input IDTs Tᵢ; and
a signal analyzer connected to said receiving IDT,
one of said input IDTs Tᵢ receiving an input electric signal via said switch, exciting a first SAW in said input piezoelectric substrate, and transmitting said first SAW to said output piezoelectric substrate along said upper end surface of said nonpiezoelectric plate,
one of said output IDTs Rᵢ transducing said first SAW to electric signals Eⱼ (j=1, 2, . . . , n), of which the phase delays linearly correlate to SAW propagation lanes Wⱼ (j=1, 2, . . . , n) between said one of said input IDTs Tᵢ and said one of said output IDTs Rᵢ on said upper end surface of said nonpiezoelectric plate, and detecting one of said electric signals Eⱼ only when touching one of said SAW propagation lanes Wⱼ,
said common transmitting IDT receiving said one of said electric signals Eⱼ, and exciting a second SAW in said output piezoelectric substrate,
said receiving IDT transducing said second SAW to an output electric signal, and
said signal analyzer sensing said one of said SAW propagation lanes Wⱼ by finding out the phase of said output electric signal, and by checking which of said input IDTs Tᵢ receives said input electric signal when said output electric signal appears at said receiving IDT.

14. An ultrasonic touch-position sensing system as defined in claim 13, wherein
said common transmitting IDT consists of a coding IDT having a coded pattern,
said receiving IDT consists of a decoding IDT having the same construction pattern as said coding IDT,
said coding IDT exciting said second SAW based on said coded pattern in said output piezoelectric substrate when receiving said one of said electric signals Eⱼ,
said decoding IDT detecting a pulse as said output electric signal when receiving said second SAW, and
said signal analyzer sensing said one of said SAW propagation lanes Wⱼ by finding out the phase of said pulse, and by checking which of said input IDTs Tᵢ receives said input electric signal when said pulse appears at said decoding IDT.

15. An ultrasonic touch-position sensing system as defined in claim 13, wherein said interdigital periodicity P_{N} is equal to the product of said interdigital periodicity P and cos θ, and said overlap length L_{P} is equal to not only the product of said overlap length L and sec θ, but also the product of said interdigital periodicity P and cosec θ.

16. An ultrasonic touch-position sensing system as defined in claim 13, wherein said input-, and output piezoelectric substrates are made of a piezoelectric ceramic, respectively, the polarization axis thereof being parallel to the thickness direction thereof.

17. An ultrasonic touch-position sensing system as defined in claim 13, wherein said input-, and output piezoelectric substrates have a thickness smaller than said interdigital periodicity P, and said nonpiezoelectric plate has a thickness larger than three times said interdigital periodicity P.

18. An ultrasonic touch-position sensing system as defined in claim 13, wherein the phase velocity of said first SAW on said nonpiezoelectric plate alone is higher than that in said input-, and output piezoelectric substrates alone.

19. An ultrasonic touch-position sensing system as defined in claim 13 further comprising an amplifier connected between said signal analyzer and said input IDTs Tᵢ.
